(19) United States
(12) Patent Application Publication
(10) Pub. No.: US 2015/0010847 A1
(43) Pub. Date: Jan. 8, 2015

(54) METHOD FOR THE PRODUCTION OF A PROTON EXCHANGE MEMBRANE FOR A FUEL CELL BY MEANS OF SOLVENT-CASTING

(71) Applicant: COMMISSARIAT A L'ENERGIE ATOMIQUE ET AUX ENERGIES ALTERNATIVES, Paris (FR)

(72) Inventors: Yannick Molmeret, Eybens (FR); Arnaud Morin, Grenoble (FR)

(21) Appl. No.: 14/368,666

(22) PCT Filed: Dec. 21, 2012
(86) PCT No.: PCT/FR2012/053044

§ 371 Date: Jun. 25, 2014

(30) Foreign Application Priority Data
Jan. 18, 2012 (FR) 1250518

(51) Int. Cl. H01M 8/10; B29C 39/00

(52) U.S. Cl. CPC H01M 8/1039; B29C 39/003; H01M 2008/1095; H01M 2300/0082; B29K 2027/16
USPC 429/492; 264/299

(57) ABSTRACT

Method of preparing a proton-exchange membrane for a fuel cell including placing in solution in a solvent a polymer selected from the group consisting of polymers having at least one monomer exhibiting a fluorinated group; adding at least one superacid to the polymer solution; mixing the solution; casting the solution containing the polymer and the superacid on a substrate; evaporating the solvent; and recovering the membrane. The used solvent is chemically stable in the presence of the superacid.

### FIELD OF THE INVENTION

The present invention relates to a method of preparing by evaporative casting a proton exchange membrane for a PEMFC (“Proton Exchange Membrane Fuel Cell”).

The field of use of the invention mainly relates to current generators, having their operating principle based on the conversion of chemical energy into electric energy and into heat by electrochemical reaction, particularly between hydrogen and oxygen.

### BACKGROUND OF THE INVENTION

Typically, a proton exchange membrane fuel cell (PEMFC) comprises an anode where the fuel, H₂, is oxidized into protons and electrons, and a cathode where the oxygen is reduced into water according to the following reactions:

H₂→2H⁺+2e⁻ (anode oxidation)

4H⁺+4e⁻+O₂→2H₂O (cathode reduction)

In a PEMFC, the electrodes are separated by an electrolyte, or proton-exchange membrane, the membrane/electrode assembly (MEA) forming the cell core. The proton-exchange membrane forms an electronically-insulating proton conducting medium. In other words, the membrane enables protons to pass from the anode to the cathode while preventing gases and electrons from passing from one electrode to the other. Further, current collectors ensure the electron transfer from the electrode to the external circuit.

Two types of membranes are mainly used in commercial cells.

The first type is formed of a cation-exchange polymer, such as Nafion® (Dupont) or Aquivion® (Solvay-Solexis), which are perfluorinated copolymers comprising sulfonate groups SO₃⁻, called perfluorosulfonate ionomers. The proton conductivity is provided by a strong acid group, SO₃H, which is highly hydrophilic and easily dissociates in water to form charged species capable of displacing. In such membranes, the proton conductivity is provided by the H₃O⁺ and H₅O₂⁺ species (solvated protons) and increases with the quantity of water forming the medium where the species displace.

Such membranes formed of a cation-exchange polymer require the presence of water to obtain a sufficient proton conductivity to reach the performance desired for the different applications, that is, generally greater than 10⁻² S·cm⁻¹. Now, the quantity of water in the membrane strongly depends, among others, on the relative humidity of the incoming gases. This thus implies the presence of incoming gas humidification agents and, accordingly, complexifications and a decrease in the reliability of the system associated with the PEMFC. This problem is even more acute at high temperature. Indeed, the energy and the amount of water necessary to hydrate incoming gases increase along with temperature and become crippling for the system efficiency, in particular above 90° C. Further, the mechanical properties of such membranes, and accordingly the membrane durability, strongly decrease as the temperature increases, particularly beyond 90° C. Finally, their permeability to gases also significantly increases with temperature, thus resulting in an acceleration of chemical aging mechanisms in membranes and of electrochemical aging mechanisms in electrodes. However, these membranes have the advantage of enabling the PEMFC to be started very rapidly at ambient temperature and even for temperatures lower than 0° C., down to −10° C.

Thus, membranes based on perfluorosulfonate ionomers are generally nominally used between 0 and 80° C.

The second type of membranes used in commercial cells concerns membranes based on polybenzimidazole (FBI) and phosphoric acid H₃PO₄ (He R, Li Q, Xiao G, Bjerrum N J “Proton conductivity of phosphoric acid doped polybenzimidazole and its composites with inorganic proton conductors”, J. of Memb. Sci., 226, 2003, 169-184). Such membranes may be formed by impregnation with phosphoric acid, for example, by immersion for 7 days before drying for 24 hours.

Document US 2008/031746 describes a method of preparing a membrane based on PBI. According to this method, a polyazole-type polymer is first dissolved in an anhydrous solution of strong acid. The resulting solution is then deposited on a substrate, and then gelled by being placed in contact with water. The membrane is obtained after doping of the gel thus obtained, with phosphoric acid or sulfuric acid. In this method, the solvent is a strong acid which thus enables to solubilize the polyazole. This strong acid is removed on doping of the gel. The membrane is thus formed of a polyazole soaked with an inorganic acid which is either phosphoric acid, or sulfuric acid.

The PBI/H₃PO₄ association enables to increase the temperature of use of the PEMFC up to 220° C. due to the chemical stability of FBI and to the nature of the electrolyte which can conduct the protons in the absence of water. Thus, since the proton conduction mechanism requires no water, it is also possible to use dry gases. However, this proton conduction mechanism has a high activation energy. Accordingly, the conductivity of these membranes strongly decreases at temperatures lower than 120° C. They are even unusable at temperatures lower than 40° C. due to the phosphoric acid crystallization. The cell should thus be preheated before use. These membranes further require a run-in time of some hundred hours.

Thus, PBI/H₃PO₄ membranes are generally nominally used between 120 and 180° C.

Typically, in nominal operation, from 40 to 50% of the energy generated by a PEMFC is formed of heat. Accordingly, during its operation as an electric generator, a PEMFC should be cooled down. However, the greater the temperature interval between the cell and the ambient temperature, the easier it is to dissipate the generated heat. In other words, the cooling system is simpler and less bulky when the cell operates at high temperature. This is all the more important for the transport application, which has the most drastic constraints in terms of compactness and of reliability of the system. The internal temperature of heat engines being in the order of 110° C., this operating temperature is often aimed at for this application, and even for the cogeneration application.

It should also be noted that the hydrogen used as fuel may comprise carbon monoxide capable of poisoning the platinum-based catalysts by adsorption. Now, the adsorption of carbon monoxide on platinum decreases as the temperature increases, in particular beyond 80° C. ([Baschuk J J, Li X. “Carbon monoxide poisoning of proton exchange membrane fuel cells” Int. J. Energy Res. 2001, 25, 695-713). Accordingly, a PEMFC operating at a temperature greater than 80° C. may also contribute to decreasing the adsorption of carbon monoxide on the catalyst.

Accordingly, it would be advantageous to be able to increase the operating temperature of PEMFCs having their membrane based on perfluorosulfonate ionomer and to decrease the operating temperature of PEMFCs having their membrane based on PBI/H₃PO₄ for many applications, to have a nominal operating temperature between 100 and 130° C. However, for most applications, it is generally desirable to have a system with a PEMFC which is operative with no external energy input and rapidly, even at ambient temperature.

The development of a membrane capable of operating at a low humidification rate and in a temperature range from 0 to 130° C. would thus enable to do away with prior art problems.

The Applicant has developed a method of preparing a polymeric membrane for a PEMFC capable of being used in a wide range of temperatures as compared with prior art membranes, in particular those comprising phosphoric acid.

### SUMMARY OF THE INVENTION

The method forming the object of the invention enables to obtain a membrane doped with an acid by evaporative casting. Conversely to prior art methods, this method enables to dope the membrane before the casting of the membrane and the evaporation of the solvents.

Further, the invention enables to use superacids as dopants despite their highly oxidizing character.

More specifically, the present invention relates to a method for preparing a proton exchange membrane for a fuel cell advantageously comprising:
placing in solution in a solvent a polymer selected from the group comprising polymers having at least one monomer exhibiting a fluorinated group such as tetrafluoroethylene (TFE), hexafluoropropene (HFP), or vinylidene fluoride (VDF);
adding at least one superacid to the polymer solution;
mixing the solution thus obtained;
casting the solution containing the polymer and the superacid on a substrate;
evaporating the solvent;

recovering the membrane;

said solvent being chemically stable in the presence of the superacid

According to the mass ratio between the superacid and the polymer, the membrane may appear in the form of a self-supporting film. It may also be a gel.

Independently from its shape, it has mechanical properties compatible with a use as a fuel cell.

However, the membrane advantageously appears in the form of a self-supporting film having a thickness which may be in the range from 10 to 100 micrometers, the polymer being inflated by the superacid.

Generally, the substrate enables to spread the solution. It is thus chemically stable at the contact of the solvents and of the superacid, at least at the solvent evaporation temperature.

The substrate may be formed of a polymer film, possibly a metal plate. It preferably is a glass plate.

The polymers having their monomer(s) exhibiting fluorinated groups enable to obtain a film having good mechanical properties. Further, they are very stable regarding the possible oxidation by superacids but also during the operation as a cell.

This fluorinated polymer may be a (co)polymer obtained from at least one tetrafluoroethylene (TFE), hexafluoropropene (HFP), or vinylidene fluoride (VDF) monomer. It may particularly be selected from the group comprising poly(VDF-co-HFP) (PVDF-HFP), perfluoroalkoxy (PFA) polymers, poly(ethylene-co-tetrafluoroethylene) (polyETFE), or poly perfluoro(ethylene-propylene) (polyFEP).

During the first step of the method comprising placing the polymer in solution in a solvent, the concentration thereof may advantageously be in the range from 60 g/l to 400 g/l, more advantageously still in the order of 300 g/l.

The molar concentration depends on the selected polymer grade, as well as on its molar mass. In the case of PVDF-HFP (Mw=400,000), the molar concentration may be in the range from 0.001 mol/l to 0.00015 mol/l, advantageously 0.00075 mol/l.

Superacid means a chemical compound which is more acid than pure sulfuric acid. In other words, it here is an acid having a pKa smaller than −3. Preferably, the superacids are organic superacids having fluorinated groups.

It may particularly be a compound selected from the group comprising disulfuric acid (pKa=−3.1), fluorosulfuric acid (pKa=−10), trifluoromethane sulfonic acid (TFSA) (pKa=−14.9), fluoroantimonic acid (pKa=−25).

The superacid may be directly incorporated into the polymer solution, particularly when it is in liquid form.

Further, according to another specific embodiment, it may be previously placed in solution in a solvent chemically stable in the presence of said superacid. This solvent may be identical to that used in the first step of the method comprising placing the polymer in solution.

In this case, the mass ratio between the superacid and the solvent where it is previously placed in solution is adjusted according to the nature of the solvent and/or of the superacid. In the case of TFSA, this ratio may be in the range from 0.02 to 0.5, preferably in the range from 0.1 to 0.2.

Generally, the solvents used in the method of the invention are chemically stable in the presence of a superacid. They may advantageously be selected from the group comprising polar organic solvents such as: DMF (dimethylformamide), DMSO (dimethyl-sulfoxide), acetonitrile, dimethylsulfone. They may also be a mixture of solvents.

According to a particularly preferred embodiment, the solvent is dimethylsulfoxide (DMSO).

According to the specific embodiment comprising the prior placing in solution of the superacid in a solvent, it may be judicious, or even necessary, to cool down the solution, this step of mixture/dilution being capable of being exothermic.

The solvents are preferably evaporated by heating of the substrate having the solution containing the polymer and the superacid cast thereon, at a temperature advantageously in the range from 25 to 150° C., and more advantageously still in the order of 80° C. The evaporation conditions are determined according to the nature of the solvent, to provide a slow and homogeneous evaporation.

To avoid problems associated with the acidity of the superacid, and particularly its reactivity with the solvents, the method forming the object of invention may implement, on preparation of the membrane, the use of the anhydride of the superacid or of a superacid salt.

When the superacid is in the form of the superacid anhydride, the superacid is hydrolyzed after evaporation of the solvents, preferably by action of the air humidity on the membrane soaked with superacid anhydride. The hydrolysis of the superacid anhydride may thus be carried out generally within less than one hour. According to another specific embodiment, the hydrolysis may also be carried out by immersion of the membrane in an aqueous solution.

When the superacid is in the form of a superacid salt, the salt advantageously is an alkaline, alkaline earth, or ammonium salt, or a mixture thereof.

On preparation of the membrane, and after evaporation of the solvents, the superacid salt is acidified by immersion of the polymer membrane soaked with superacid salt into a solution containing an acid having a pKa smaller than 0, advantageously smaller than −3.

This acid solution is advantageously an aqueous solution having an acid concentration in the range from 0.5 to 10 mol/l, more advantageously still from 1 to 5 mol/l.

The time of stay of the membrane in the acid solution should be as short as possible to avoid the elution of the superacid. It is advantageously in the range from 10 seconds to 60 minutes, more advantageously still from 30 seconds to 2 minutes.

The present invention also relates to a proton-exchange membrane soaked with superacid and obtained by the above-described method.

It also relates to a fuel cell comprising said proton-exchange membrane.

The polymer of the membrane soaked with superacid ensures the mechanical resistance of the membrane. It does not contribute to the proton conductivity of the membrane. According to the type of membrane used, it can thus be envisaged to select the polymer according to its mechanical properties, without for all this to modify the membrane conductivity properties.

Preferably, the proton conductivity of the proton-exchange membrane prepared according to the method of the invention is thus totally ensured by the doping by means of the superacid. The polymer used is thus advantageously deprived of groups having an acid proton.

The invention and the resulting advantages will better appear from the following examples, provided as a non-limiting illustration of the invention.

### DETAILED DESCRIPTION OF THE INVENTION

### Preparation of a PVDF-HFP+TFSA Membrane According to the Invention

A membrane of 120 cm² is prepared as follows:

600 mg of PVDF-HFP polymer (Sigma-Aldrich, reference 427160) are dissolved in 2 ml of DMSO in a pillbox, under a slow stirring and at a 40° C. temperature. For the dissolution to be complete, the mixture is left for 8 hours under stirring.

Simultaneously, 0.5 g of TFSA (that is, approximately 0.3 mL) is mixed progressively, to avoid any heating with 2 mL of DMSO, in a pillbox, under a slow stirring.

The superacid/solvent solution is then progressively added to the previously cooled polymer/solvent solution. The obtained solution is slowly stirred from 15 minutes to be homogenized.

The content of the pillbox is then poured on a glass plate (here, a Petri dish, with a 120 cm² surface area) and is placed on a plate heated up to 80° C.

After 12 hours of drying, the obtained membrane is removed from the plate and may be stored.

The membrane obtained in such conditions has a thickness in the range from 80 to 90 micrometers. It is however not excluded for solvent traces to remain inside.

The membrane is translucent.

### Preparation of a PVDF-HFP+TFSA Anhydride Membrane

This membrane is prepared according to the same method as hereabove, taking the precaution of placing in a neutral anhydrous atmosphere to avoid a hydrolysis of the anhydride before the end of the membrane manufacturing.

The obtained membrane is opaque, and should be activated, by hydrolyzing the Tf2 (TFSA anhydride). To achieve this, the membrane is placed in ambient air, so that the humidity present ensures a slow hydrolysis of the Tf2.

After one hour if the membrane is thin (in the order of 40 micrometers) or up to 4 hours if the membrane is thick (between 100 and 120 micrometers), the membrane has become translucent and may be assembled in a fuel cell.

### Ex-Situ Conductivity Measurements on PVDF-HFP Membranes Doped with a Superacid

Different membranes based on PVDF-HFP have been manufactured and doped by means either of TFSA, or of Tf2 (which has then been hydrolyzed). The conductivity measurements are performed ex-situ, that is, in ambient air, that is T=25° C. and a 50% relative humidity. The conductivity values have been copied in the following table.

| Composition | IEC (mEq/g) | Thickness (μm) | Conductivity (mS/cm) |
|---|---|---|---|
| PVDF-HFP + Tf2 | 4.12 | 110 | 40 |
| PVDF-HFP + | 2 | 30 | 12 |
| TFSA | | | |
| PVDF-HFP + Tf2 | 2 | 60 | 12 |
| PVDF-HFP + | 3 | 90 | 17 |
| TFSA | | | |
| PVDF-HFP + Tf2 | 3 | 90 | 30 |
| PVDF-HFP + Tf2 | 3 | 90 | 23 |

The IEC corresponds to the ion exchange capacity of the membrane. It is expressed in mEq/g (milliequivalents with respect to the weight in grams of the membrane). It is advantageously in the range from 0.5 to 5 mEq/g, more advantageously still from 2 to 3 mEq/g.

Indeed, the shape in which the membrane appears may depend on its IEC. For an IEC in the range from 0.5 to 5 mEq/g, the membrane appears in the form of a self-supporting film. However, beyond 5 mEq/g, it generally is a gel.

As an example, the mass ratio (established for TFSA) Mass_{TFSA}/Mass_{PVDF} is 0.08 for an IEC of 0.5 mEq/g, and of 1.5 for an IEC of 4 mEq/g. For a greater IEC, this ratio is thus higher. For example, in the case of an IEC of 5.5 mEq/g, the mass ratio is 4.7.

The proton conductivity of the membrane obtained according to the method forming the object of the invention can be measured according to techniques known by those skilled in the art (see, particularly: Lee et al. Ind. Eng. Chem. Res. 2005, 44, 7617-7626; or Casciola et al. Journal of Power Sources 20066, 162, 141-145). Generally, and unless otherwise indicated, the conductivity is measured at the ambient temperature (25° C.) and with a 50% relative humidity. It is measured across the membrane thickness.

1. Method for preparing a proton-exchange membrane for a fuel cell comprising:
placing a polymer in solution in a solvent;
adding at least one superacid to the polymer solution;
mixing the solution;
casting the solution containing the polymer and the superacid on a substrate;
evaporating the solvent;
recovering the membrane;
said solvent being chemically stable in the presence of the superacid,
wherein the polymer is a fluorinated polymer selected from the group consisting of the polymers obtained from at least one monomer having a fluorinated group.

2. The method for preparing a proton exchange membrane for a fuel cell of claim 1, wherein the solvent is selected from the group consisting of dimethylformamide, dimethylsulfoxide, acetonitrile, and dimethylsulfone.

3. The method for preparing a proton exchange membrane for a fuel cell of claim 1, wherein prior to its addition, the superacid is placed in solution in a solvent.

4. The method for preparing a proton exchange membrane for a fuel cell of claim 1, wherein the superacid is in the form of the anhydride of the superacid.

5. The method for preparing a proton exchange membrane for a fuel cell of claim 4, wherein the superacid anhydride is hydrolyzed after evaporation of the solvents.

6. The method for preparing a proton exchange membrane for a fuel cell of claim 1, wherein the superacid is in the form of a superacid salt.

7. The method for preparing a proton exchange membrane for a fuel cell of claim 6, wherein the membrane comprising a polymer soaked with superacid salt is dipped into a concentrated solution of an acid having a pKa smaller than 0.

8. The method for preparing a proton exchange membrane for a fuel cell of claim 1, wherein the solvents are evaporated by heating of the substrate up to a temperature in the range from 25 to 150° C.

9. The method for preparing a proton exchange membrane for a fuel cell of claim 1, wherein the polymer is selected from the group consisting of poly(VDF-co-HFP) (PVDF-HFP), perfluoroalkoxy (PFA) polymers, poly(ethylene-co-tetrafluoroethylene) (polyETFE), and poly perfluoro(ethylene-propylene) (polyFEP).

10. The method for preparing a proton exchange membrane for a fuel cell of claim 1, wherein the monomer having a fluorinated group is selected from the group consisting of tetrafluoroethylene (TFE), hexafluoropropene (HFP), and vinylidene fluoride (VDF).

11. The method for preparing a proton exchange membrane for a fuel cell of claim 6, wherein the superacid appears in the form of a salt selected from the group consisting of alkaline, alkaline earth, ammonium salts, and mixtures thereof.

12. The method for preparing a proton exchange membrane for a fuel cell of claim 8, wherein the heating temperature is 80° C.

13. The method for preparing a proton exchange membrane for a fuel cell of claim 1, wherein the solvent is dimethylsulfoxide.

14. A proton exchange membrane obtained by the method of claim 1.

15. A fuel cell comprising the proton exchange membrane of claim 14.
